(19) United States
(12) Patent Application Publication
(10) Pub. No.: US 2010/0050803 A1
(43) Pub. Date: Mar. 4, 2010

(54) Manual control device

(75) Inventors: Robert L. Stamate, Chillicothe, IL (US); Norval P. Thomson, Dunlap, IL (US); Daniel Sergison, East Peoria, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: Caterpillar Inc., Peoria, IL (US)

(21) Appl. No.: 12/203,735

(22) Filed: Sep. 3, 2008

(51) Int. Cl. G05G 1/00

(52) U.S. Cl. 74/471 XY; 74/504; 341/20

(57) ABSTRACT

A manual control (200) includes a stem (206) having an elongate shape and a centerline. A grip (204) is pivotally connected to an end of the stem (206) at a pivot point (222), and a sensor array (226) is integrated with the grip (204). The sensor array (226) includes at least one sensor disposed to measure a pivotal displacement of the grip (204) relative to the stem (206). The grip (204) and the sensor array (226) are pivotal with respect to the stem (206) at the pivot point (222).

### TECHNICAL FIELD

This patent disclosure generally relates to manual control devices.

### BACKGROUND

Machines having implements are typically controlled by a combination of control devices. For example, an operator may use one device to move the machine into a desired direction, for example, a steering wheel or yolk, a different device to accelerate and decelerate the machine, for example pedals or levers, and yet a different device, for example, a joystick, to operate an implement of the machine, such as a bucket or shovel.

When machines operate on rough or uneven terrain, roughness in the ride of the machine may translate into undesired motions of the operator's hand while using a control to operate the machine, especially in the case where a joystick is used. A typical joystick includes an elongated structure, the “stick,” which pivots about a pivot point. Various sensors or other devices are arranged to translate the motion of the stick about the pivot point into electrical signals or mechanical motions that operate to move the implement of the machine or perform any other function of the machine that is arranged to receive commands from the joystick.

In a typical joystick, the operator grips the stick such that motion of the operator's wrist and arm causes displacement of the stick, which in turn generates positional commands for a machine system. In applications where the machine vibrates or shakes during operation, for example, an earthmoving machine operating on rough surfaces, an aircraft flying in turbulent conditions, a boat operating on rough seas, and so forth, increasing distance between the operator's hand gripping the stick and the pivot point of the joystick can effect an increase in the inaccuracy of the operator's control over motion of the stick.

Various attempts have been made to address such issues of instability. One example of a manual control having a reduced distance, as compared to a typical joystick, between the operator's hand and the pivot point of the manual control can be seen in U.S. Pat. No. 4,738,417 (the '417 patent), which issued on Apr. 19, 1988, and is assigned on its face to the FMC Corporation, of Chicago, Ill. The '417 patent discloses a hand operated control for a rough riding vehicle. The control includes a truncated sphere having a soft hand grip movably mounted thereon. A position sensing mechanism is partially encompassed within the truncated sphere and is connected to the soft hand grip and to a computer for sending control signals to the vehicle. In the device disclosed in the '417 patent, the soft hand grip is closely disposed around the truncated sphere such that it is held in place when it is not moved by the operator. When moved by the operator, the soft hand grip can be moved controllably relative to the truncated sphere and to the position sensing mechanism about a center within the grip to transmit control signals to the vehicle such as direction of movement signals.

### SUMMARY

The disclosure describes, in one aspect, a manual control that includes a stem having an elongate shape and a centerline. A grip is pivotally connected to an end of the stem at a pivot point, and a sensor array is integrated with the grip. The sensor array includes at least one sensor disposed to measure a pivotal displacement of the grip relative to the stem. The grip and the sensor array are pivotal with respect to the stem at the pivot point.

In another aspect, the disclosure describes a machine that includes at least one actuator operating to perform a function. An electronic controller is operably connected to the at least one actuator and disposed to receive at least one command signal. The electronic controller is arranged to send a command to the at least one actuator based on the at least one command signal. The machine further includes a manual control that is connected to the machine and includes a stem, a grip that is pivotally connected to the stem at a pivot point, and a sensor array. The sensor array is disposed in the grip and includes at least one sensor. The at least one sensor generates the at least one command signal that is indicative of a pivotal displacement of the grip and of the sensor array relative to the stem. The at least one sensor is connected to the electronic controller via an electrical conductor such that the at least one actuator can perform the function in response to pivotal motion of the grip and of the sensor array relative to the stem.

In yet another aspect, the disclosure describes a manual control assembly. The manual control assembly includes a support structure and a base structure. The base structure is connected to the support structure and a post is adjustably connected to the base structure. An armrest, which is adapted for supporting and retaining the forearm of an operator, is adjustably connected to the post. A control limb, which is defined on the base structure, extends upward from the base structure and supports a manual control. The manual control is connected to the control limb and includes a stem and a grip, which is pivotally connected to the stem at a pivot point. A sensor array that includes at least one sensor is disposed in the grip and is moveable in unison with the grip. The at least one sensor can generate at least one command signal that is indicative of a pivotal displacement of the grip and the sensor array relative to the stem. The grip can be selectively pivoted relative to the stem when the grip is manually engaged by the operator.

### BRIEF DESCRIPTION OF THE DRAWINGS

FIG. 1 is an outline view of a machine in accordance with the disclosure.

FIG. 2 is an outline view of a manual control in accordance with the disclosure.

FIG. 3 is a section of the manual control shown in FIG. 2.

FIG. 4 through FIG. 6 are simplified views showing the pivotal motion of a manual control in accordance with the disclosure.

FIG. 7 is a simplified view, from a top perspective, of a manual control in accordance with the disclosure.

FIG. 8 is an outline view of a manual control in accordance with the disclosure during service.

FIG. 9 is an outline view of a manual control assembly that includes an armrest in accordance with the disclosure.

### DETAILED DESCRIPTION

This disclosure relates to manual controls for use by equipment operators to control functions of their equipment. A manual control as disclosed herein reduces or altogether eliminates issues of control instability due to ride roughness during operation of the equipment. One embodiment for a manual control is described relative to operation of an earthmoving machine but, as can be appreciated, the same principles may be used in a variety of other machines and applications where ride roughness may influence the control accuracy of an operator. For example, the machine disclosed herein is a wheel loader. Even though a wheel loader is used for illustration, it is understood that the systems and methods disclosed herein have universal applicability and are suited for other types of vehicles, for example, trucks, backhoe loaders, compactors, harvesters, graders, tractors, pavers, scrapers, skid steer vehicles, tracked vehicles, and so forth. Moreover, other types of machines that experience ride roughness during operation are contemplated. Some examples of such machines include aircraft operating in turbulent conditions, boats, hovercrafts or other marine applications operating in rough seas, and so forth. In general, the systems and methods disclosed herein are suitable for all applications involving manual controls that yield electronic signals in response to operator hand and arm motion. For instance, the manual control disclosed herein may be used to control electronic devices, for example, computers.

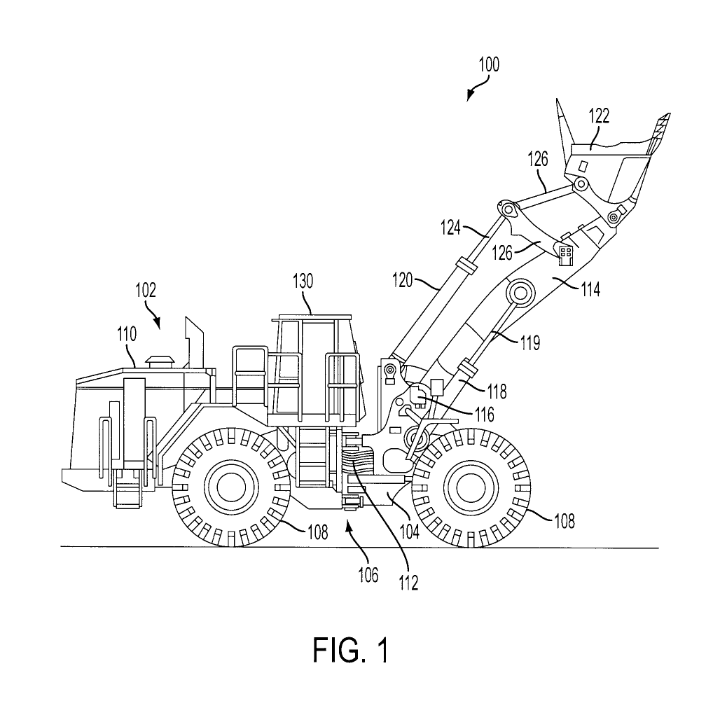

FIG. 1 shows an outline of a wheel loader 101 as one example of a machine 100 that is suitable for the manual control disclosed herein. The wheel loader 101 includes an engine frame portion 102 connected to a non-engine frame portion 104 by an articulated joint 106. Each of the engine frame portion 102 and non-engine frame portion 104 includes a respective axle connected to a set of wheels 108. The engine frame portion 102 includes the engine 110, which may operate a hydraulic pump (not shown) or generator (not shown). The pump impels a flow of fluid through a network of fluid conduits 112 extending to various components and actuators of the wheel loader 101. Alternatively, the generator may produce electrical power that is used for moving the machine and/or for operating various systems of the machine.

In the embodiment shown, a pair of lift arms 114 is connected to the non-engine frame portion 104 of the wheel loader 101 at a hinge 116. The hinge 116 allows the lift arms 114 to pivot with respect to the non-engine frame portion 104. Motion of the lift arms 114 may be controlled by a hydraulic cylinder or lift actuator 118. The lift actuator 118 is hingeably connected at both ends between the non-engine frame portion 104 and the lift arms 114 such that the lift arms 114 may pivot upwards when the lift actuator 118 extends an actuator arm 119. In the case of a hydraulic system, the actuator arm 119 of the lift actuator 118 may be connected to a piston that moves when fluid under pressure is introduced on one side of the piston. In the case of an electrical system, the actuator arm 119 may be connected to a worm gear or any other arrangement that is operated by a motor and that translates operation of a motor into mechanical motion. In a similar fashion, a tilt actuator 120 may operate to tilt a bucket 122 that is pivotally connected to a distal end of the lift arms 114. The actuator arm 124 of the tilt actuator 120 may be connected to the bucket 122 via two intermediate linkages 126.

Motion of the various portions of the wheel loader 101 can be controlled via appropriate devices by an operator occupying the cab 130 of the wheel loader 101 during operation. For example, a single manual control (not shown) may allow the operator to control the function of the lift actuators 118 and the tilt actuators 120 by generating one or more command signals that are input to an electronic controller (not shown). The electronic controller may be disposed to receive the command signal(s) and issue appropriate commands to hydraulic valves, electrical switches, or any other appropriate devices that can cause motion of the lift actuators 118 and the tilt actuators 120. Accurate control of the lift actuators 118 and the tilt actuators 120 is beneficial to efficient operation of the wheel loader 101 under all circumstances, especially when the wheel loader 101 is in motion, and particularly when the wheel loader 101 is moving over rough terrain.

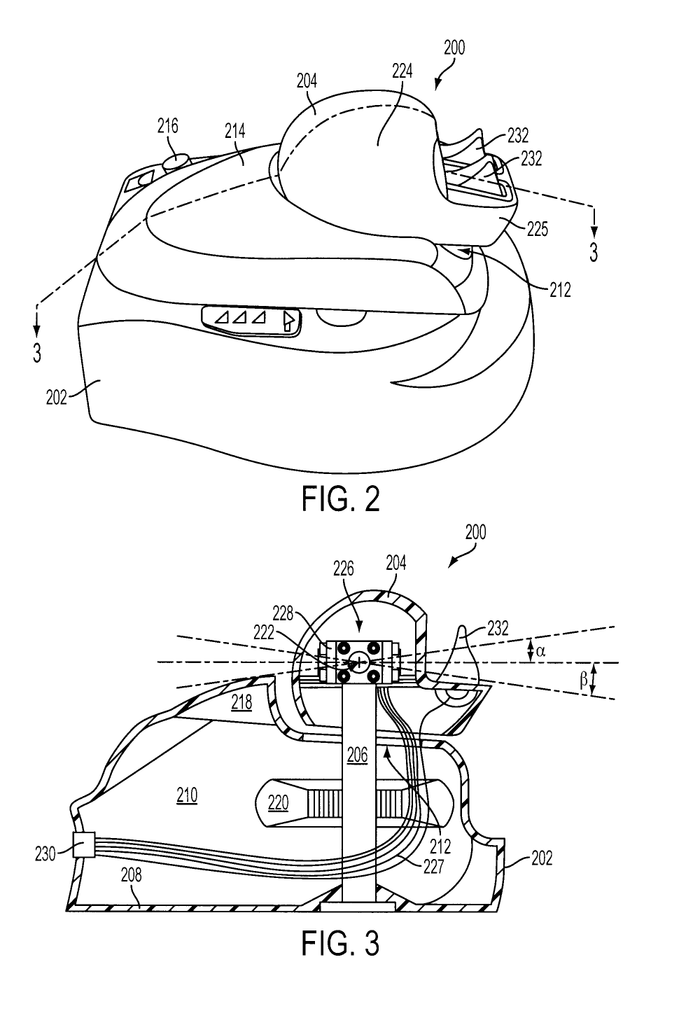

An outline view from the side of a manual control 200 is shown in FIG. 2, with a cross section therethrough along a line 3-3 shown in FIG. 3. The manual control 200 includes a base 202 and a grip 204 that is pivotally connected to the base 202. In the arrangement shown, the grip 204 is the portion of the manual control 200 that the operator grasps and moves to control an implement of the machine. For example, the operator of the wheel loader 101 (FIG. 1) may control the lift and tilt of the bucket 122 (FIG. 1) and/or the motion of the wheel loader 10 1 by appropriate displacements of the grip 204 relative to the base 202, which displacements are translated into signals effecting the desired operation, as is described below.

As shown in FIG. 3, the base 202 has an elongate shaft or stem 206 connected to a bottom portion 208 of the base 202. Even though the manual control 200 shown in this embodiment includes the base 202, it is understood that the base 202 is optional. In an alternative embodiment, for example, the stem 206 may be connected directly to a portion of a machine or to an existing base for a control (not shown) without having the base 202 to enclose the stem 206. The stem 206 in this embodiment is preferably straight and extends away from the bottom portion 208, but any other shape may be used. The stem 206 extends through an internal cavity 210 of the base 202 and protrudes, at least partially, out of the base 202 through a neck opening 212. Even though the base 202 is shown as a separate component it can, alternatively, be integrated with another component of the machine. Externally, the base 202 forms a wrist pad 214 and may have other actuators or components that control functions of the wheel loader 101 (FIG. 1) associated therewith, for example, an electrical switch 216 that operates the horn (not shown) of the wheel loader 101 (FIG. 1). Internally, the base 202 may have supporting struts 218, gussets, or other features that lend rigidity and structural strength to the base 202, as well as a z-axis or stem-axis rotational sensor 220 and/or other structures lending support or measuring angular displacement along a centerline of the stem 206.

The grip 204 is pivotally connected to the stem 206 at a pivot point 222. The grip 204 may define a palm portion 224 and a finger portion 225 (shown in FIG. 2). The palm portion 224 may have a generally spherical shape, the center of which coincides with or is adjacent to the pivot point 222. When an operator is using the manual control 200, the operator's palm rests on the palm portion 224. The operator's fingers can be curved around the palm portion 224 and reside above the finger portion 225. As is described in further detail below, the grip 204 is connected to or integrated with a sensor array 226, which pivots on the stem 206 about the pivot point 222. The sensor array 226 can be any type of sensor arrangement that can generate one or more signals indicative of the pivotal position of the grip 204 relative to the stem 206, and/or a rotational displacement of the grip 204 relative to the base 202 about the centerline of the stem 206. Measurements acquired by the sensor array 226 can be communicated to a controller (not shown) that is arranged to carry out operations consistent with motion of the grip 204. Stated differently, the hand motions of the operator that are imparted onto the grip 204 may be appropriately translated into the performance of various functions of a machine or any other device.

In addition to the sensor array 226, the grip 204 may further include finger switches 232 that may be arranged to perform other functions of the wheel loader 101 (FIG. 1), for example, lift and lower and/or tilt the bucket 122 (FIG. 1). Even though two finger switches 232 are shown, it is understood that fewer or more switches can be used. In general, any type of switch or other control may be included in the grip 204. For example, other devices such as keyboards, and so forth, that can translate finger motions of the operator into commands for various systems of the machine may be used. Electrical signals indicative of the state of each of the sensors that are included or connected to the manual control 200 may be communicated to the appropriate systems of the machine via a series of electrical conductors 227. The electrical conductors 227 may be connected to the sensor array 226 and to any other sensors in the manual control 200 such that they can carry electrical signals via, for example, a connector 230, to other conductors of the machine (not shown).

The grip 204 may pivot about the stem 206 by an appropriate angle that is narrow enough to be suitable for prolonged comfortable use by the operator, as well as being wide enough to provide an acceptable range of motion for the sensor array 226. Hence, the grip 204 may pivot toward the operator by a first maximum angle, α, and away from the operator by a second maximum angle, β, for a total maximum pivotal range of an included angle that is equal to α+β. In the embodiment shown, the grip 204 is arranged to pivot within an included angle of as little as 5 degrees, as much as 45 degrees, or any other included angle within that range in any direction relative to the pivot point 222.

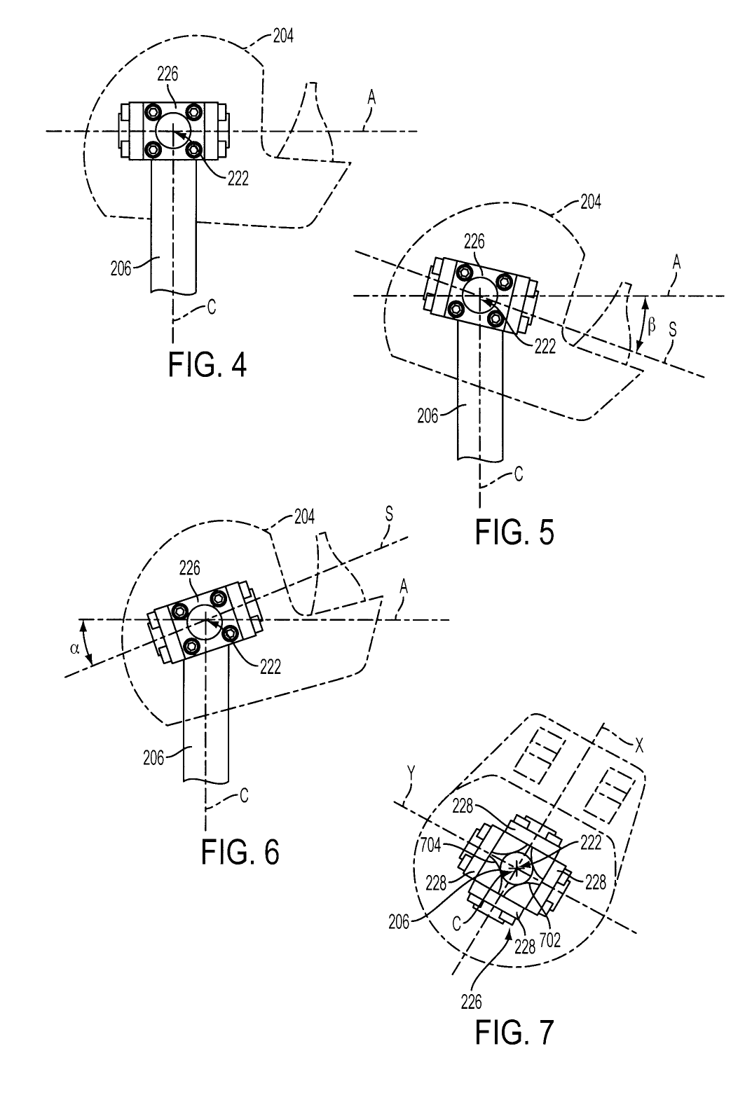

Detail views that further illustrate the pivotal motion between the grip 204 and the stem 206 about the pivot point 222 are shown in FIGS. 4 through 6. In these figures, the grip 204 is shown in phantom line for the sake of clarity to illustrate the relative motion between the sensor array 226 and the stem 206 along one direction or plane. In FIG. 7, the same notations are used to show a top perspective of the grip 204, again in phantom line, and of the sensor array 226 that is disposed therein relative to two orthogonal planes. A centerline, C, of the stem 206 and a reference zero pivot line, A, are denoted by long-dash/short-dashed lines. To indicate the pivotal displacement of the grip 204 relative to the stem 206, dotted reference lines, S, are used in FIG. 5 and FIG. 6 that are indicative of displacement of the sensor array 226 relative to the reference zero pivot line A. It can be appreciated that even though pivotal motion along one plane is shown, the description applies to pivotal motion about an infinite number of planes that intersect the centerline C and the pivot point 222. Similarly, it can be appreciated that even though the rotational motion of the grip 204 about the centerline C is not denoted in the figures, the disclosure applies to rotational motion that extend over an infinite number of angles.

In the view of FIG. 4, the sensor array 226 and grip 204 are in a rest or idle position relative to the stem 206. The sensor array 226 and the grip 204 are connected to move in unison and can optionally rotate about the centerline C of the stem 206. In FIG. 5, the sensor array 226 and grip 204 are displaced in one direction relative to the stem 206. In this first displaced position, the sensor array 226 may measure, by displacement in the appropriate rotational sensors 228 thereof, the relative angle(s) between the displaced position and the idle position. Similarly, in FIG. 6, the sensor array 226 and grip 204 are displaced in an opposite direction relative to the stem 206. In this second displaced position, the sensor array 226 may measure, by displacement in the appropriate rotational sensors 228, the relative angle(s) between the second displacement position and either the idle position, the first displaced position shown in FIG. 5, or any other intermediate position. In other words, the sensor array 226 may include sensors that can measure either an absolute angular displacement or a relative angular displacement of the grip 204 relative to the stem 206.

Turning now to the view of FIG. 7, the sensor array 226 includes four rotational sensors 228, with each rotational sensor 228 being arranged to measure and/or quantify angular displacement of the grip 204 about the pivot point 222 in one plane or, as is required by most applications and as shown in this embodiment, in two orthogonal planes simultaneously. In this embodiment, the four rotational sensors 228 are arranged to measure components of pivotal displacement along a first plane, X, along a second plane, Y, or in any intermediate plane therebetween by measuring components of the displacement along the first plane X and the second plane Y.

The first plane X and second plane Y may intersect along the centerline C of the stem 206, which may also include the pivot point 222. As shown in the view of FIG. 7, each of the four rotational sensors 228 may be connected to a header piece 702 that pivotally connects the grip 204 with the stem 206. The header piece 702 may have four links or actuators 704 that transfer the relative motion of the grip 204 to each of the four rotational sensors 228. Each of the rotational sensors 228 may include a potentiometer that is arranged to generate a change in voltage when rotated or linearly displaced within a sensor housing, or may alternatively be a non-contacting sensor, for example, a Hall Effect sensor, that includes no moving parts. In either case, the sensor array 226 is able to track the pivotal motion of the grip 204 about the stem 206 in any direction.

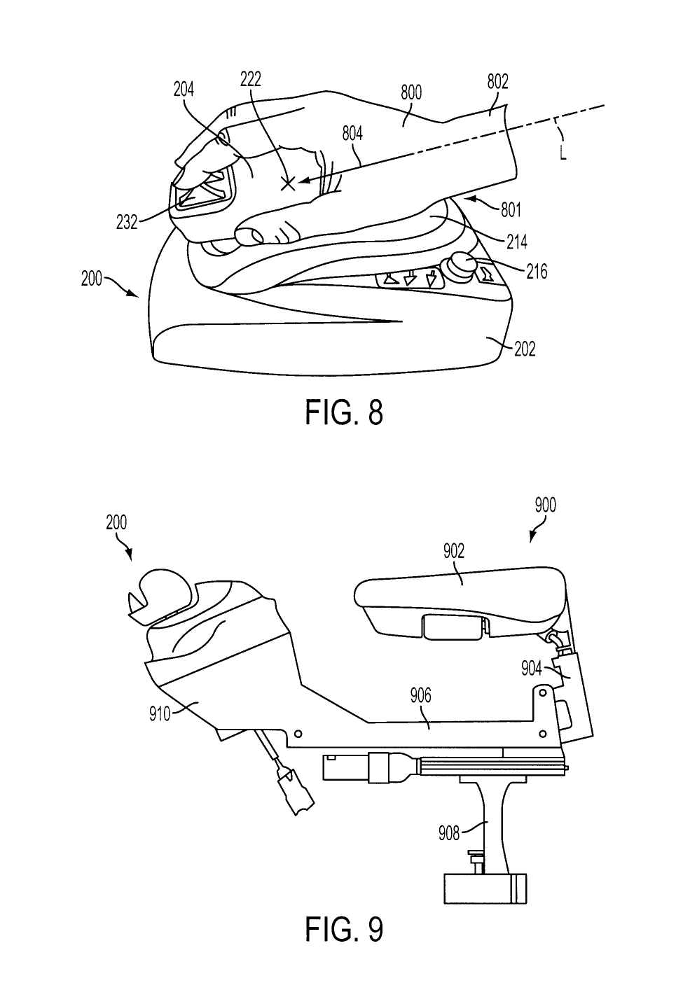

The manual control 200 is advantageously less prone to control instabilities from involuntary motion of the operator's hand in applications where the operator is subjected to relative rough riding conditions than a typical joystick control. One reason for this improved performance is that the pivot point 222 is located at a small or negligible distance from the center of motion of the operator's hand operating the manual control 200. The outline view of FIG. 8 further illustrates this aspect. In this view, the operator's hand 800 is shown engaging the grip 204 of the manual control 200, with the operator's wrist 801 resting on the wrist pad 214 to provide additional stability. Even though the operator's right hand is shown, the manual control 200 is equally applicable to operation by the operator's left hand as well. A centerline, L, of the operator's forearm 802, which is shown in dash-dot-dashed line, if extended toward the grip 204 as an imaginary line 804, which is shown as a solid-lined/open-headed arrow, intersects or at least passes very close to or within 10 mm of the pivot point 222. Hence, the distance from the pivot point 222 from the imaginary line 804 is very small or close to zero so that a lever arm tending to move the grip 204 relative to the pivot point 222 is also very small or close to zero. This relatively close positioning of the pivot point 222 to the centerline L allows for greater stability and control of the manual control 200 by the operator.

An outline view of a manual control assembly 900 in accordance with the disclosure is shown in FIG. 9. In this embodiment, the manual control 200 is combined with an armrest 902 to improve the stability of the operator's arm during operation of the manual control 200. Here, the armrest 902 is positioned to support and retain the operator's forearm 802 (FIG. 8) in a stable fashion and in an aligned manner relative to the manual control 200. As can be appreciated, stabilization of the operator's forearm 802 (FIG. 8) will also stabilize the operator's hand 800 (FIG. 8) relative to the manual control 200. Stabilization of the operator's hand 800 (FIG. 8) relative to the manual control 200, in combination with the minimal or negligible distance existing between the pivot point 222 of the grip 204 relative to the centerline L (also shown in FIG. 8), will yield improved stability of operation and relative immunity from control instabilities resulting from ride roughness of the machine.

In the embodiment shown in FIG. 9, the armrest 902 is connected to a post 904, whose height can be adjusted. The post 904 is adjustably connected to a base 906 that is connected to the machine 100 (FIG. 1) via a support structure 908. The support structure 908 may be a stand alone structure or may, alternatively, be integrated with a seat (not shown) occupied by the operator during service. The base 906 extends toward a control limb 910 that forms a platform upon which the manual control 200 is connected. Portions of the control limb 910 and/or other sections of the base 906 may be hollow or form channels that accommodate electrical conductors (not shown) that may be connected to the manual control 200. The base 906 may be further adjustable for angular and/or linear positioning relative to the support structure 908 to suit the needs of individual operators and to improve comfort.

### INDUSTRIAL APPLICABILITY

The present disclosure is applicable to manual controls for machines whose operation requires precise and stable operator hand motions to control functions of the machine. The foregoing disclosure describes aspects of the manual control relative to the operation of an earthmoving machine, but one can appreciate that any other type of machine having operator controls, or any other device, such as a computer, may benefit from the present disclosure. The manual control disclosed herein is particularly well suited for replacing traditional joystick controls used to control machines or electronic devices in various applications, to provide more stable and precise control by the operator. As an added advantage, machines having joystick controls may be well suited for upgrade by replacing their current joystick controls to a manual control in accordance with the disclosure.

Even though the embodiment for a manual control disclosed herein is described as having two switches that are operated by the operator's fingers, more or fewer switches may be incorporated into the grip or any other portion of the manual control to suit the specific demands of each application. Further, although a wheel loader is illustrated in FIG. 1, the term “machine” may refer to any machine that performs some type of operation associated with an industry such as mining, construction, farming, transportation, or any other industry known in the art. For example, a machine 100 (FIG. 1) may be an earth-moving machine, such as an excavator, dump truck, backhoe, motor grader, material handler or the like. Similarly, although a bucket 122 is illustrated as the attached implement, an alternate implement may be included. Any implements may be utilized and employed for a variety of tasks, including, for example, loading, compacting, lifting, brushing, and include, for example, buckets, compactors, forked lifting devices, brushes, grapples, cutters, shears, blades, breakers/hammers, augers, and others. Additionally, other types of machines may benefit from the manual control as disclosed herein. Some examples of other types of machines include aircraft of any type, helicopters, boats or other seagoing vessels, land-based and water-based cranes, trains, and so forth.

We claim:

1. A manual control, comprising:
a stem having an elongate shape and a centerline;
a grip pivotally connected to an end of the stem at a pivot point;
a sensor array integrated with the grip, the sensor array including at least one sensor disposed to measure a pivotal displacement of the grip relative to the stem;
wherein the grip and the sensor array are pivotal with respect to the stem at the pivot point.

2. The manual control of claim 1, wherein the grip has a generally spherical shape, and wherein a center point of the grip is disposed at least adjacent to the pivot point.

3. The manual control of claim 1, further including a base, wherein the stem is connected to the base and at least partially protrudes from the base through an opening defined in the base.

4. The manual control of claim 1, wherein the sensor array includes three additional sensors for a total of four sensors, each of the four sensors disposed to measure the pivotal displacement of the grip and the sensor array relative to the stem in any direction.

5. The manual control of claim 1, further including:
a palm portion defined on the grip, the palm portion adapted to engage the palm of an operator's hand; and
a finger portion defined on the grip, the finger portion adapted to be disposed beneath at least one finger of the operator's hand.

6. The manual control of claim 1, wherein the grip and the sensor array are connected to move in unison, and wherein the grip is arranged to pivot with respect to the stem about the pivot point within an included angle of angular displacement in all directions.

7. The manual control of claim 6, further including a rotational sensor disposed to measure rotation of the stem relative to a centerline axis of the stem, wherein the grip and the sensor array are arranged to rotate in unison about the centerline axis of the stem.

8. A machine, comprising:
at least one actuator operating to perform a function;
an electronic controller operably connected to the at least one actuator, the electronic controller disposed to receive at least one command signal and send a command to the at least one actuator based on the at least one command signal;
a manual control connected to the machine and including:
a stem;
a grip pivotally connected to the stem at a pivot point;
a sensor array disposed in the grip, the sensor array including at least one sensor;
the at least one sensor generating the at least one command signal that is indicative of a pivotal displacement of the grip and of the sensor array relative to the stem;
wherein an electrical conductor connects the at least one sensor with the electronic controller such that the at least one actuator is adapted to perform the function in response to pivotal motion of the grip and of the sensor array relative to the stem.

9. The machine of claim 8, further including:
a palm portion defined on the grip and having a generally spherical shape;
wherein a center point of the palm portion is disposed at least adjacent to the pivot point.

10. The machine of claim 8, further including:
a finger portion defined on the grip, the finger portion adapted to be disposed beneath at least one finger of a hand of an operator when the hand is engaged with the grip; and
at least one finger switch disposed in the finger portion, the at least one finger switch adapted to be actuated by motion of the at least one finger.

11. The machine of claim 8, wherein the sensor array includes three additional sensors for a total of four sensors, each of the four sensors disposed to measure the pivotal displacement of the grip and the sensor array relative to the stem in any direction.

12. The machine of claim 8, wherein the manual control further includes:
a base disposed around at least a lower portion of the stem;
an opening formed in the base;
wherein an upper portion of the stem is arranged to protrude from the base through the opening.

13. The machine of claim 12, further including an electrical switch disposed on the base, the electrical switch adapted for activation by an operator of the machine.

14. The machine of claim 8, wherein the grip is arranged to pivot with respect to the stem about the pivot point within an included angle of angular displacement in all directions.

15. A manual control assembly, comprising:
a support structure;
a base structure connected to the support structure;
a post that is adjustably connected to the base structure;
an armrest connected to the post, the armrest adapted for supporting and retaining a forearm of an operator;
a control limb defined on the base structure, the control limb extending upward from the base structure;
a manual control connected to the control limb, the manual control including:
a stem;
a grip pivotally connected to the stem at a pivot point;
a sensor array disposed in the grip, the sensor array being moveable in unison with the grip, the sensor array including at least one sensor;
the at least one sensor being adapted to generate at least one command signal that is indicative of a pivotal displacement of the grip and the sensor array relative to the stem;
wherein the grip is adapted to be selectively pivoted relative to the stem when the grip is manually engaged by the operator.

16. The manual control assembly of claim 15, further including:
a palm portion defined on the grip and having a generally spherical shape;
wherein a center point of the palm portion is disposed at least adjacent to the pivot point.

17. The manual control assembly of claim 16, wherein the forearm of the operator defines a centerline, and wherein the pivot point is arranged to lie generally on the centerline when the operator manually engages the grip and the forearm of the operator is disposed on the armrest.

18. The manual control assembly of claim 15, wherein the sensor array includes three additional sensors for a total of four sensors, each of the four sensors disposed to measure the pivotal displacement of the grip and the sensor array relative to the stem in any direction.

19. The manual control assembly of claim 15, wherein the manual control further includes:
a base disposed around at least a lower portion of the stem;
an opening formed in the base;
a wrist pad defined on the base;
wherein an upper portion of the stem is arranged to protrude from the base through the opening, and wherein a wrist of the operator is arranged to rest on the wrist pad when the operator manually engages the grip.

20. The manual control assembly of claim 19, further including an electrical switch disposed on the base, the electrical switch adapted for activation by the operator.
